(19) United States
(12) Patent Application Publication
(10) Pub. No.: US 2010/0070437 A1
(43) Pub. Date: Mar. 18, 2010

(54) Information Management for Information Display Systems

(75) Inventor: Louis S. Sickenius, Longmont, CO (US)

Correspondence Address: Marcia L. Doubet Law Office, P.O. Box 422859, Kissimmee, FL, 34742-2859, US

(73) Assignee: INTERNATIONAL BUSINESS MACHINES CORPORATION, Armonk, NY (US)

(21) Appl. No.: 12/211,043

(22) Filed: Sep. 15, 2008

(51) Int. Cl. G06F 3/048; G06F 15/18

(52) U.S. Cl. 706/12; 715/781; 715/788

(57) ABSTRACT

A user-customizable information management solution, providing protection (e.g., privacy and/or security protection) for displayed information that may reduce or prevent exposure of sensitive and/or confidential information. In one aspect, a viewing aperture is controlled by the user and provides a view of a subset of the information displayed, where information not within the aperture is blocked or obscured to eliminate or reduce viewability. Optionally, simultaneous use of more than one viewing aperture may be supported. In another aspect, predefined information management instructions are used for determining how to protect a portion or portions of a document. The instructions may specify particular text and/or graphics categories defined by the user as being sensitive. Portions of the document that contain corresponding text and graphics are located, using a software-based search, and are blocked or obscured according to the predefined instructions. Dynamic tuning may be supported, whereby the user dynamically selects additional text/graphics for protecting.

### BACKGROUND OF THE INVENTION

The present invention relates to information display systems, and deals more particularly with providing security/privacy management for information displayed thereupon.

When using a computer and particularly when using mobile computing devices such as laptop computers, a security or privacy exposure may arise when information displayed on the display of the computing device can be viewed, whether intentionally or inadvertently, by others.

### BRIEF SUMMARY OF THE INVENTION

The present invention is directed to information management for displayed information. In one aspect, this comprises: building a view of information for display; applying a user-defined viewing aperture to the built view, thereby creating a protected view where a first portion of the information that is displayable within the viewing aperture is not visually altered and is therefore unprotected while remaining portions of the information that are not displayable within the viewing aperture are protected by visually altering those remaining portions; and displaying the protected view on a display.

In another aspect, this comprises: building a view of information for display; applying user-defined information management instructions to the built view, thereby creating a protected view where portions of the information corresponding to the information management instructions are visually altered and are therefore protected for displaying while remaining portions of the information are not visually altered and are therefore not protected for displaying; and displaying the protected view on a display. In either aspect, the information may be security-sensitive and/or privacy-sensitive.

Embodiments of these and other aspects of the present invention may be provided as method, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIG. 1 illustrates a display that provides a view of a sample document containing sensitive information, and FIG. 2 shows this same sample document when a viewing aperture as disclosed herein is in use;

FIGS. 3-5 show further examples of using a viewing aperture, and in FIG. 6, multiple viewing apertures are illustrated;

FIG. 7 shows user of a viewing aperture in combination with scalable screening of a view;

FIG. 8 provides a sample user interface menu illustrating how an embodiment of the present invention may enable a user to configure view management for an embodiment using a security apertures or apertures;

FIG. 9 provides a flowchart depicting logic that may be used when implementing an embodiment that provides a security aperture or apertures;

FIG. 10 illustrates an aspect where predefined information management instructions are applied to protect a portion or portions of a document;

FIG. 11 illustrates text-level toggling of the information management protection for document portions, and FIGS. 12-14 illustrate scalable information management for document portions;

FIGS. 15-16 illustrate dynamic security tuning of the information management protection for document portions;

FIG. 17 provides a sample user interface menu, illustrating how an embodiment of the present invention may enable a user to configure the information management protection discussed with reference to FIGS. 10-16;

FIG. 18 provides a flowchart depicting logic that may be used when implementing an embodiment that provides protection for a portion or portions of a document using predefined information management instructions;

FIG. 19 depicts a data processing system suitable for storing and/or executing program code; and

FIG. 20 depicts a representative networking environment in which one or more embodiments of the present invention may be used.

### DETAILED DESCRIPTION OF THE INVENTION

Embodiments of the present invention are directed toward information management for information display systems, referred to herein (by way of illustration but not of limitation) as the display of a computing device such as a laptop computer. Using techniques disclosed herein, information management for displayed information is provided in a dynamic, flexible, and user-customizable manner by visually altering at least a portion of the displayed information.

When a computer user is viewing the computer's display, information shown on the display may be viewable to others. For example, if the computer user is on an airplane, someone in the adjacent seat or in the next row might be able to view the displayed information. As another example, information may be viewable to others when the computer is used in other public places. If the computer user is merely browsing publicly-available information, then ability of others to see that information is not typically of concern. However, if the computer user is viewing sensitive information, a security and/or privacy exposure arises when that information can be viewed by others. (For ease of reference, some discussions herein refer to security management or providing security protection, although references to security are to be interpreted as applying equally to privacy—e.g., privacy management or providing privacy protection.)

One known approach for dealing with this situation is to add a mechanical screening device to the computer, where this screening device is designed to restrict visibility from the periphery of the device. However, there are a number of drawbacks with this approach. As one drawback of these screening devices, information may be still viewable from others who are behind the computer user (e.g., in an airplane, classroom, and so forth). As another drawback, the screening devices may be awkward to work with, particularly in situations where mobility of the computer user is restricted (such as a seat of an airplane). Furthermore, the screening device is an additional piece of hardware that the computer user must remember to bring along, and if the user forgets the device (or loses it), then the user is left without protection for the viewable information. The screening devices also tend to be limited to use with computing devices having a particular display size, so that they are often not portable from one computing device to another, which may require the computer user to repeatedly invest in different screening devices (and perhaps corresponding adapters and mounting hardware as well). The screening devices may also be prone to wear and physical degradation over time. In addition, a screening device protects information only for the display to which it is physically attached: if an auxiliary display is attached to the computing device, that auxiliary device will display the information in full.

By contrast, an embodiment of the present invention provides a software-based solution. Accordingly, mechanical devices, mounting hardware, and/or adapters for attaching to a display are not required. Information protected using this software-based solution is still protected even though the computer user might change computing devices and then display that information on a different display.

In addition, an embodiment of the present invention provides a user-customizable information management solution, and a user may dynamically change the security protection for a particular document according to his or her needs, as will be described herein. The security protection provided by an embodiment of the present invention may reduce, for example, a computer user's vulnerability to identity theft by preventing exposure of sensitive and/or confidential information of the user.

In one aspect of the present invention, a viewing aperture is controlled by the user, and information displayed within this viewing aperture is not visually altered and is therefore readily viewable. The viewing aperture thereby provides a view of a subset of the displayed information, and the information not within the aperture is blocked or obscured (i.e., visually altered) to eliminate or reduce viewability. The user may define the size of this aperture, and manipulates the aperture—for example, with a cursor—to be located at an area of interest to the user. The user might move the viewing aperture from place to place around a display screen, for example, to view the subset of displayed information which is of current interest to the user. The amount of information that might be exposed to view by others is therefore reduced, according to the size of the aperture.

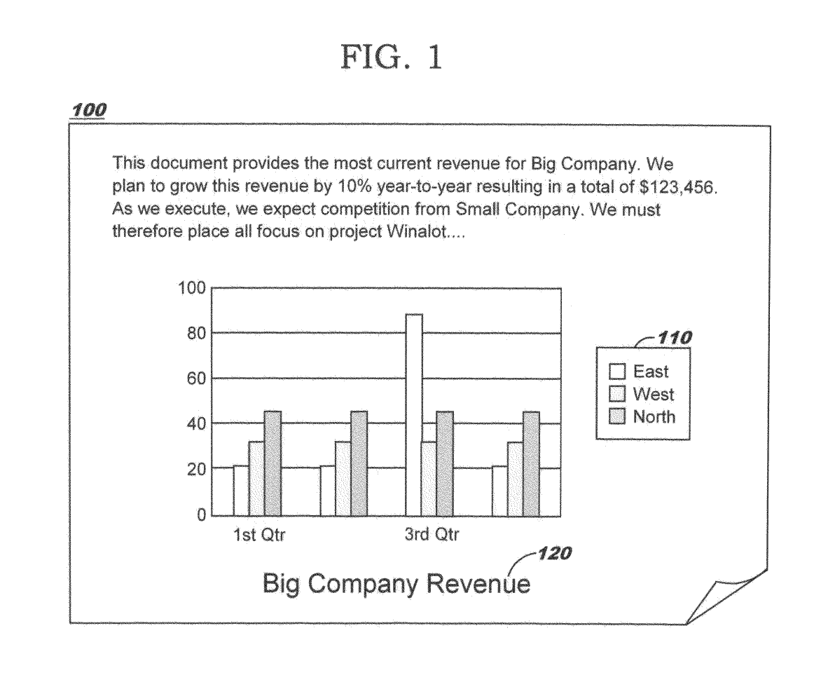

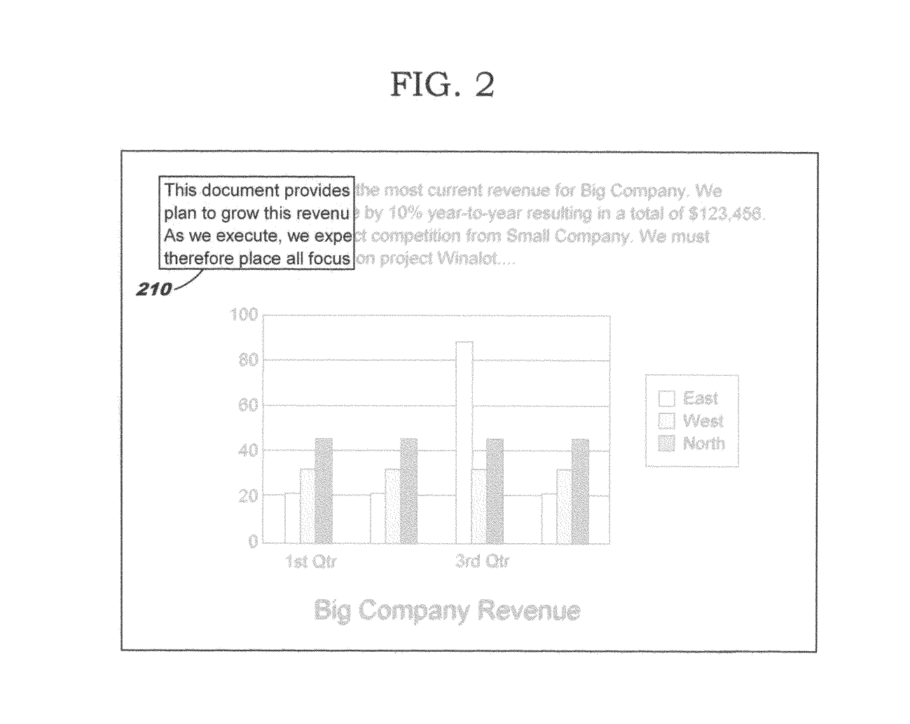

FIG. 1 illustrates a display that provides a view 100 of a sample document containing sensitive information. In this example, the document provides sensitive text and graphics. FIG. 2 shows this same sample document when a viewing aperture as disclosed herein is in use. In this example, the user has positioned viewing aperture 210 over a portion of the text. That portion remains fully viewable, while the remaining portions of the sample document are not readily viewable. (Notably, these remaining portions are not readily viewable to either the computer user or others who may be nearby.)

The user may be allowed to define the shape of the viewing aperture, in addition to the size thereof. The viewing aperture may be attachable to the cursor, such that the user can automatically move the aperture around the display by moving the cursor.

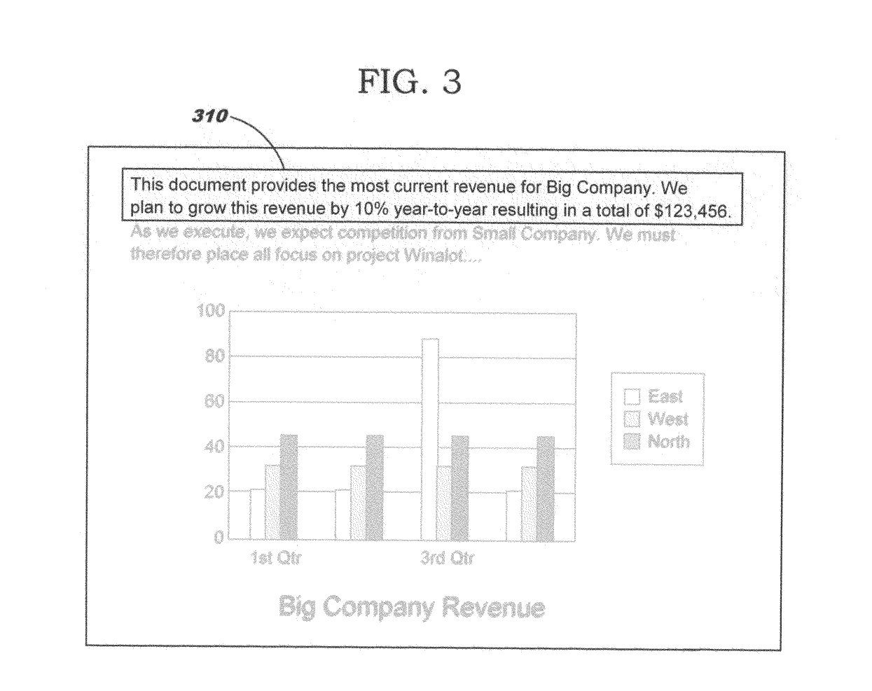

FIG. 3 shows another example of using a viewing aperture, where the same sample document from FIG. 1 is presented with aperture 310. In this example, the user has set the size of the aperture to the full width of the screen and a height of 2 rows of text. Thus, if the user is typing, the aperture will show 2 full rows of text as the user types. Preferably, the aperture will scroll down vertically each time a row of text is filled, thereby maintaining viewability of 2 rows of text. If the user is simply reading text instead of typing, the user can manually advance the aperture by moving the cursor.

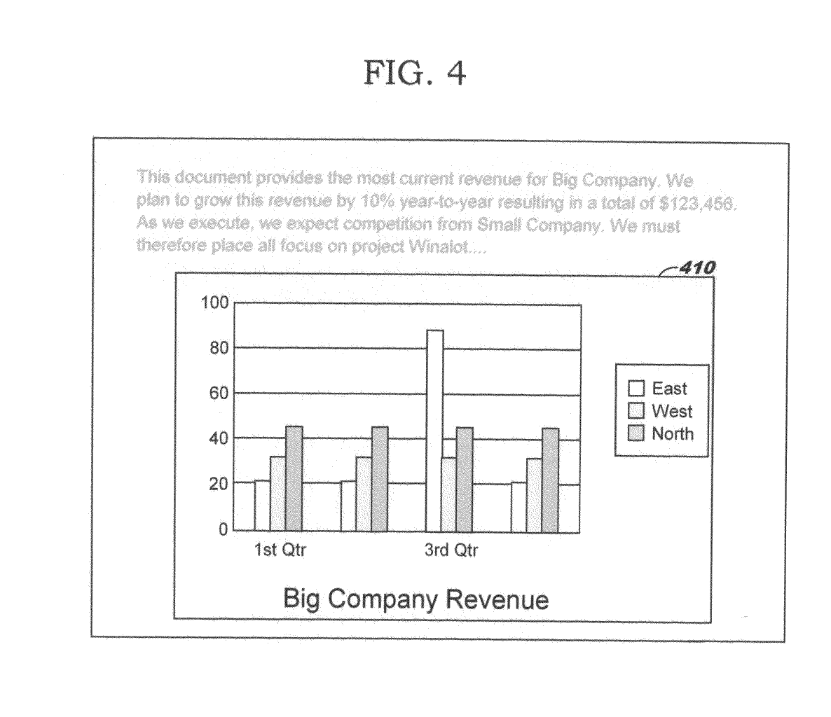

FIG. 4 shows still another example of using a viewing aperture, where the same sample document from FIG. 1 is presented with aperture 410. In this example, the user has set the aperture to allow viewing of a graphic (and the user may also be allowed to create and/or edit a graphic within the aperture). In this example, the text of the sample document is blurred, but the user retains some visibility of the text (as contrasted to fully blocking the text), thereby enabling the user to properly position the graphic within the document. The blurring of the text makes it difficult for others to be able to read it, however.

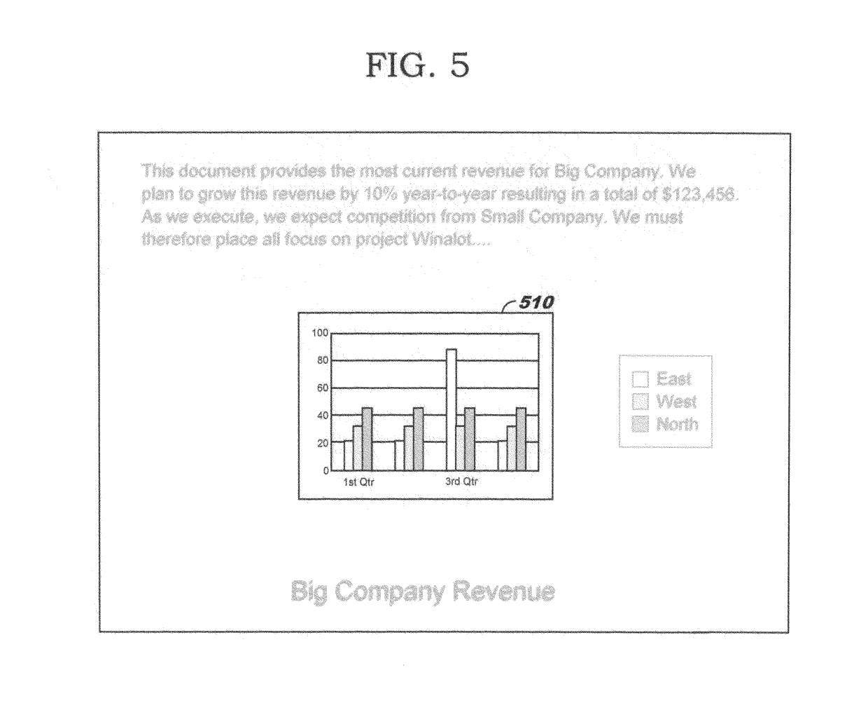

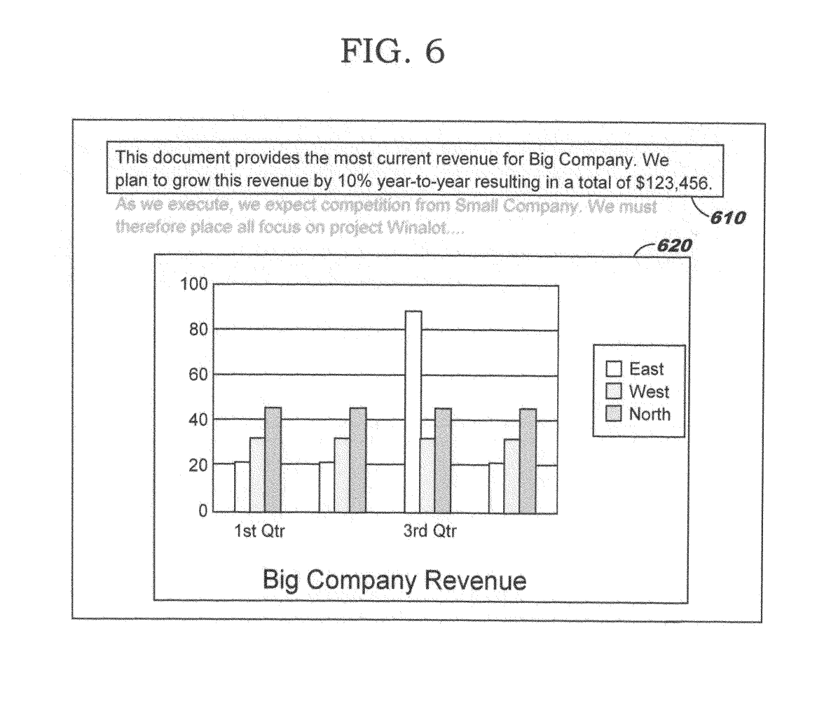

FIG. 5 shows a further example of using a viewing aperture. It may happen that the graphic presented within the sample document is itself sensitive or confidential in nature. Therefore, FIG. 5 shows how the user may shrink the size of the aperture 510, as contrasted to aperture 410 of FIG. 4, to reduce the visible portion thereof. In this example, the company name to which the graphic corresponds is blocked by positioning the aperture 510 so that it does not include the chart title “Big Company Revenue” (see 120 in FIG. 1) and the legend appearing at the right-hand of the graphic (see 110 in FIG. 1) is also omitted from the viewing aperture 510.

FIG. 6 shows an example of using multiple viewing apertures simultaneously (although an embodiment of the present invention may be limited to a single viewing aperture without deviating from the scope of the present invention). In this example, a first viewing aperture 610 is configured to show 2 rows of text, as discussed above with reference to aperture 310 of FIG. 3, and a second viewing aperture 620 is positioned to provide a view of the graphic, as discussed above with reference to aperture 410 of FIG. 4. The user can therefore focus his or her attention on these portions 610, 620 of the document, while other portions are protected (i.e., obscured or blocked from view).

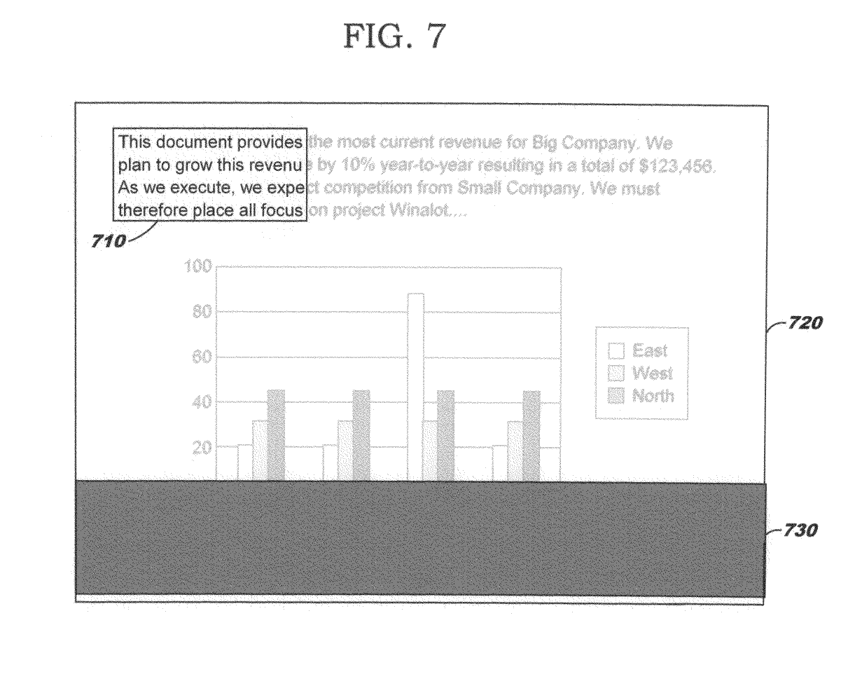

FIG. 7 illustrates use of a security aperture 710 in combination with scalable screening of a view. For this sample view, the user has specified increased screening (using blocking, in this example) for a lower portion of the view (see 730) and decreased screening (using obscuring, in this example) for an upper portion of the view (see 720). Aperture 710, by contrast, provides an unobscured, unblocked view of that portion of the document that appears within the movable aperture.

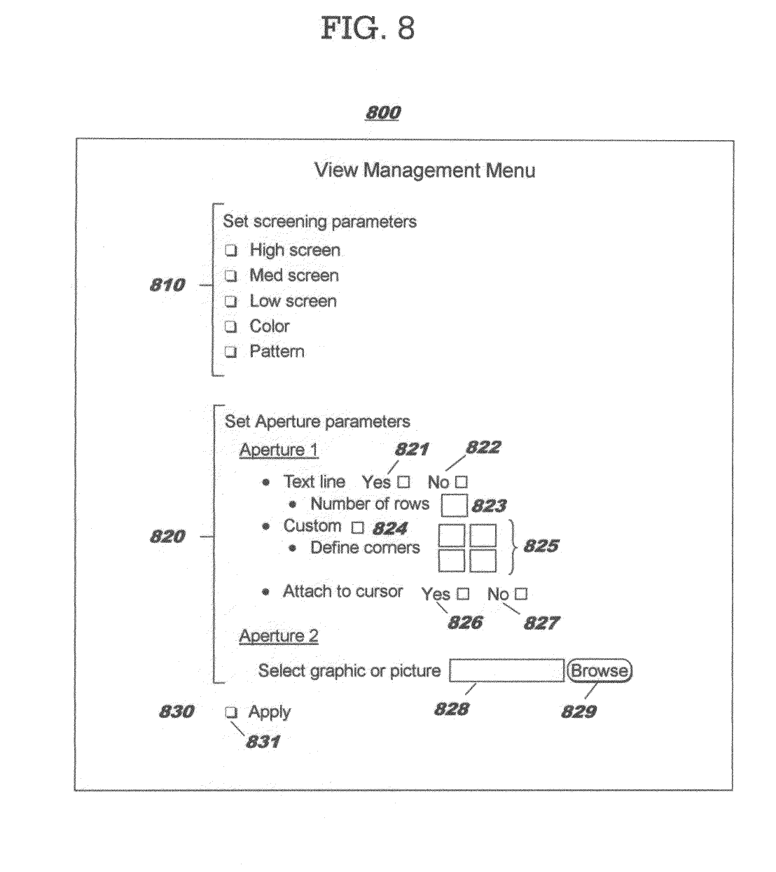

FIG. 8 provides a sample user interface menu 800, illustrating how an embodiment of the present invention may enable a user to configure view management for an embodiment using a security apertures or apertures. In this example, menu 800 displays a section 810 where the user can select from among a number of predetermined screening parameters. In this example, the selectable parameters in section 810 include high, medium, or low screen; color; and pattern. (The color and/or pattern parameters may be used, for example, to specify how a portion the display will be blocked when using a technique as illustrated at 730 in FIG. 7.) Additional, fewer, different selectable screening parameters may be provided in menu 800 without deviating from the scope of the present invention.

The sample menu 800 provides another section 820 where the user can define aperture-specific parameters. A pair of checkboxes may be provided, for example, to ask the user whether an “Aperture 1” (e.g., a default aperture) is adapted for use with lines of text. See 821, 822. When the “Yes” box 821 is checked, the user is allowed to enter a “Number of rows” value 823, specifying how many rows of text should be viewable within this aperture. (Refer to FIG. 3, above, where aperture 310 shows 2 lines of text.)

As an alternative to sizing the aperture for a particular number of rows of text, the user might choose to specify a custom size for the aperture. A checkbox may be provided with which the user can indicate this choice. See 824. When this box 824 is checked, the user may enter 4 values (e.g., into 4 entry boxes) to specify coordinates of the corners of the aperture (e.g., defining coordinates of a rectangle). See 825.

Another pair of checkboxes may be provided to ask whether the user wants the aperture to be attached to the cursor (or other pointing device, alternatively). See 826, 827. An embodiment of the present invention may also, or alternatively, allow the user to define an aperture with regard to a graphic or picture. In FIG. 8, this aperture is referred to as “Aperture 2”, and a “Browse” button 829 and text entry box 828 are provided with which the user can identify the graphic or picture.

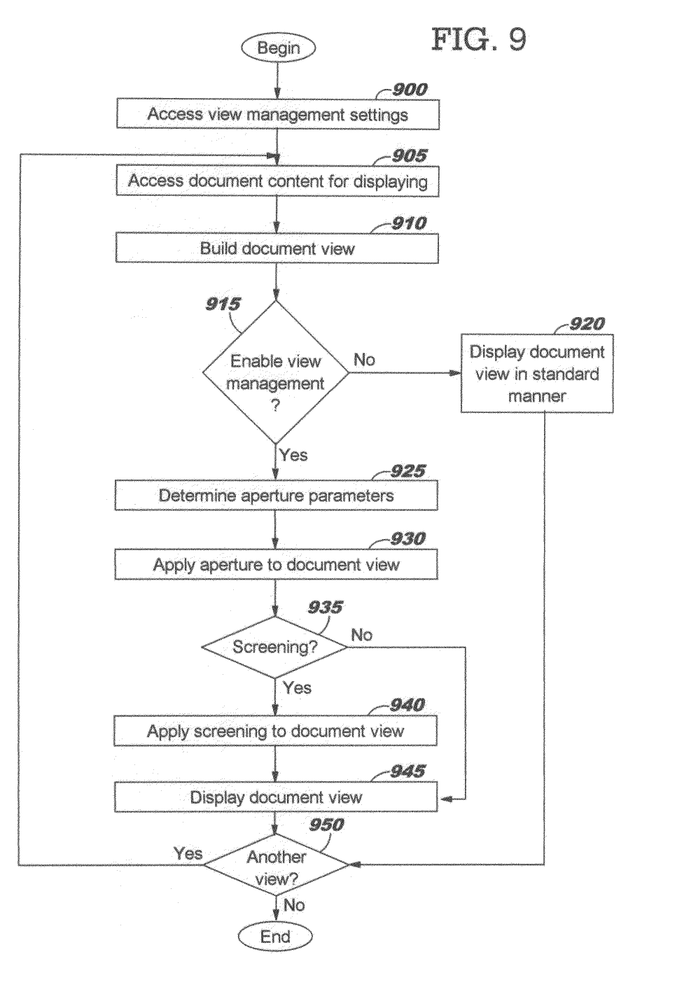

Sample menu 800 also provides a section 830 where the user can select to apply view management for an embodiment using a security aperture or apertures. A checkbox may be provided, for example. See 831. When the user selects this checkbox 831, an aperture or apertures are activated (as defined, for example, according to the definitions at 810-820). This activation will now be discussed in further detail with regard to FIG. 9.

FIG. 9 provides a flowchart depicting logic that may be used when implementing an embodiment that provides a security aperture or apertures, as will now be described. Block 900 accesses the view management settings for this user (which may been have configured, for example, using a menu of the type shown at 800 in FIG. 8). These settings may be stored in, and accessed from, a security database. Block 905 accesses document content that is to be displayed for this user. Block 910 then builds a document view from that content.

Block 915 tests whether the view management settings indicate that the document view is to include a security aperture or apertures. This may be determined, for example, by testing the “Apply” setting entered by the user at 830 of FIG. 8. If this test has a negative result (i.e., indicating that the view management is not enabled), then Block 920 displays the built document view in a standard manner, after which control transfers to Block 950.

When the test at Block 915 has a positive result, indicating that view management is enabled, processing continues at Block 925 by determining applicable aperture parameters. This may comprise testing values entered by the user at 820 of FIG. 8. If the user has selected an aperture that is applicable to a certain number of rows of text (by checking the “Yes” box at 821, for example), then the aperture size, extent, and starting location may be determined at Block 925 in view of a size of the font used in the document view built at Block 910 and a screen size of that document view. As an alternative, the aperture size, extent, and starting location may be determined at Block 925 using the specified corners (see 825 of FIG. 8, for example) for the aperture. If the user has selected for the aperture to attach to the cursor (see 826 of FIG. 8), then the starting location of the aperture is preferably set to the current position of the cursor. If the user has selected an aperture that is applicable to a particular graphic or picture (see 828, 829 of FIG. 8), then Block 925 may determine the aperture size, extent, and starting location in view of a size of that graphic/picture and its location within the document view built at Block 910.

After determining the aperture parameters at Block 925, Block 930 applies the aperture or apertures to the document view that was built at Block 910. Block 935 then tests whether screening parameters (see 810 of FIG. 8) are defined. If not, then control transfers to Block 945. Otherwise, the screening parameters are applied (Block 940) to the document view built at Block 910. The document view is then displayed (Block 945).

Following Block 920 and Block 945, control reaches Block 950, which tests whether there is another document view to be displayed for this user. If not, then the processing of FIG. 9 ends. Otherwise, control branches back to Block 905 to access the document content for that view. (Or, if view management settings are stored on a document-by-document basis, an embodiment of the present invention may return control to Block 900 to access a different set of view management settings for use with the new document view. The manner in which FIG. 9 may be altered to support this alternative approach will be obvious to those of ordinary skill in the art.)

In another aspect of the present invention, predefined information management instructions are used for determining how to protect a portion or portions of a document. The instructions may specify particular text and/or graphics categories defined by the user as being sensitive, for example. An embodiment of the present invention then locates portions of the document, using a software-based search, and blocks or obscures (i.e., visually alters) those portions according to the predefined instructions while remaining portions are readily viewable (i.e., not visually altered). Accordingly, the information protected in this manner remains protected without regard to whether additional displays or projectors are attached for auxiliary views of the information, because the protection is applied by the software before sending the information to the display for rendering.

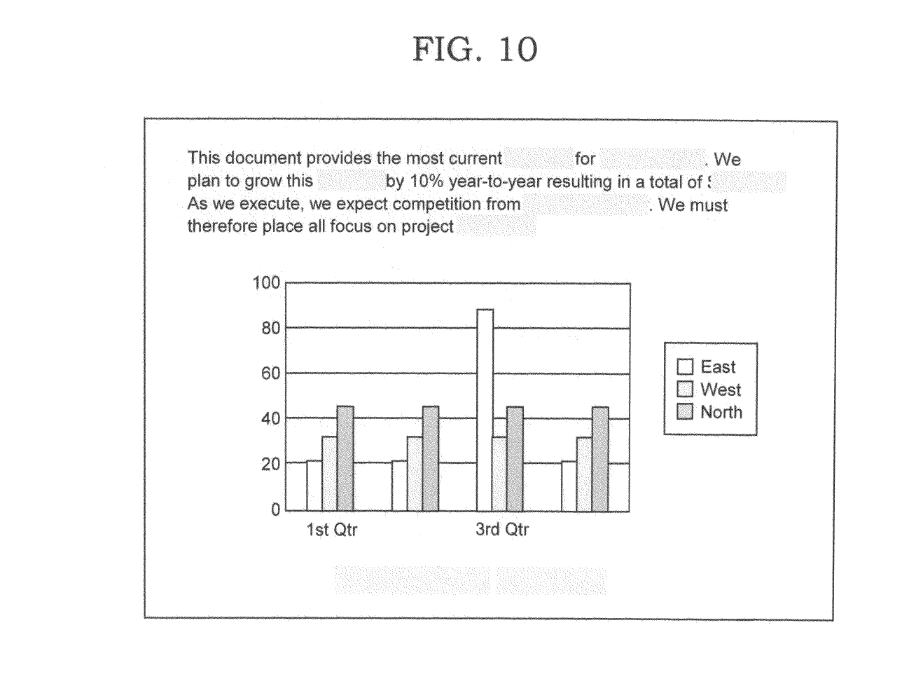

FIG. 10 provides an illustration of this aspect, where the same sample document from FIG. 1 is displayed but individual words and phrases have now been obscured from the view of the document. In this example, the following text has been obscured: “Big Company”, “Small Company”, “revenue” and “Revenue”, and “Winalot”. In addition, the dollar amount “$123,456” has been obscured. It should be noted that while discussions herein refer primarily to applying security protection to document portions of existing documents, this is by way of illustration and not of limitation. Security protection may also, or alternatively, be applied while a document is being created. With reference to FIG. 10, for example, an embodiment of the present invention may detect that the user has typed “Big Company” and then apply security protection to that phrase on the display screen.

The user may be allowed to toggle this security on and off. This toggling may apply to the entire display. For example, the user might like to get a quick glance of the entire document from FIG. 1, and then apply the security protection as shown in FIG. 10 before performing a more detailed review of the document. In this approach, the full document as shown in FIG. 1 is only briefly viewable to others who may be nearby, after which the protected version as shown in FIG. 10 is viewable. The page-level toggling may be provided (for example) by enabling the user to select a choice from a pop-up or pull-down menu, by activating a predetermined key or key sequence, and so forth.

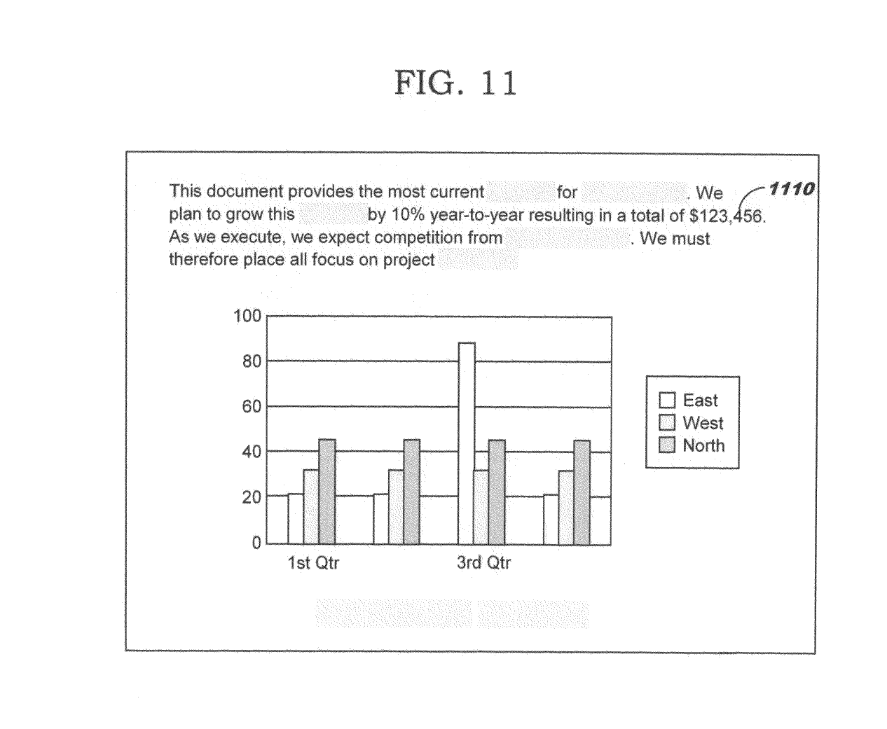

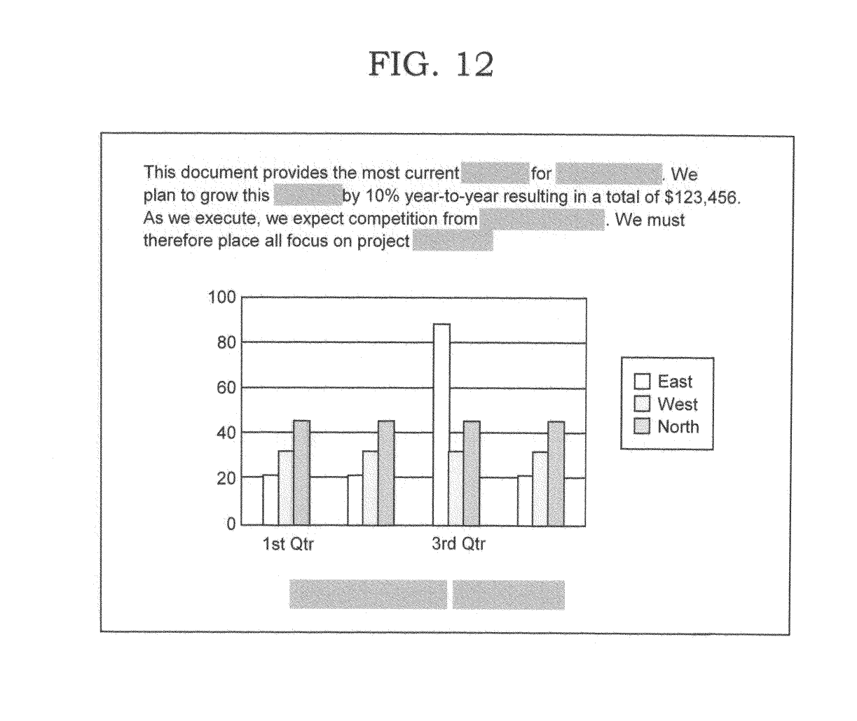

As an alternative to applying the toggling to the entire display, an embodiment of the present invention may support toggling at the level of individual portions of the document. For example, the user might view the display as shown in FIG. 10, and then decide to toggle off the protection for the dollar amount “$123,456”. The result of this text-level toggling for this example is shown in FIG. 11, where the dollar amount (see reference number 1110) then becomes viewable. The text-level toggling may be provided by enabling the user to select a particular obscured portion of the document, followed by user activation of a toggle command or instruction. In another approach, text-level toggling may occur responsive to mouse or cursor movement, whereby (for example) the user may roll the mouse cursor over an obscured or blocked portion of the document and this action automatically causes that obscured or blocked portion to become rendered in unblocked, unobscured form. The user may be allowed to configure whether this toggling-off is temporary or permanent.

An embodiment of the present invention may also provide scalable security, and this scalability may be provided at the level of a full page or for a portion (or portions) of a page. This scalability may be preset, and may be toggled on or off as needed. The scaling may comprise varying degrees of obscuring, which may range from slightly obscuring to fully obscuring (i.e., blocking) a portion or portions of a view.

This scalable security is illustrated in FIGS. 12-14. In FIG. 12, selected portions of the document are obscured with relatively dark-shaded rectangular shapes, while in FIG. 13, those same portions are obscured with somewhat lighter-shaded rectangular shapes. The shading used to obscure text in FIG. 12 may be selected to provide higher security, for example, as contrasted to a medium level of security provided by the shading used in FIG. 13. A lower level of security might be provided, when using this scalable approach, using the blurring of text as shown in FIG. 14, where the text remains somewhat visible although difficult to read. In one approach, the highest level of security causes document portions to be fully blocked from view even by the device user, while other levels may block or obscure the document portions from the device user to varying degrees.

Dynamic security tuning may be supported by an embodiment of the present invention. Rather than (or in addition to) using predefined categories of text and graphics, as discussed above with reference to FIGS. 10-14, this dynamic tuning enables the user to select text and graphics displayed on the screen and then selectively apply or remove security protection for those selected portions. The dynamic changes may apply temporarily. Alternatively, the dynamic changes may be permanent. The user may be allowed to specify whether the changes are to be temporary or permanent.

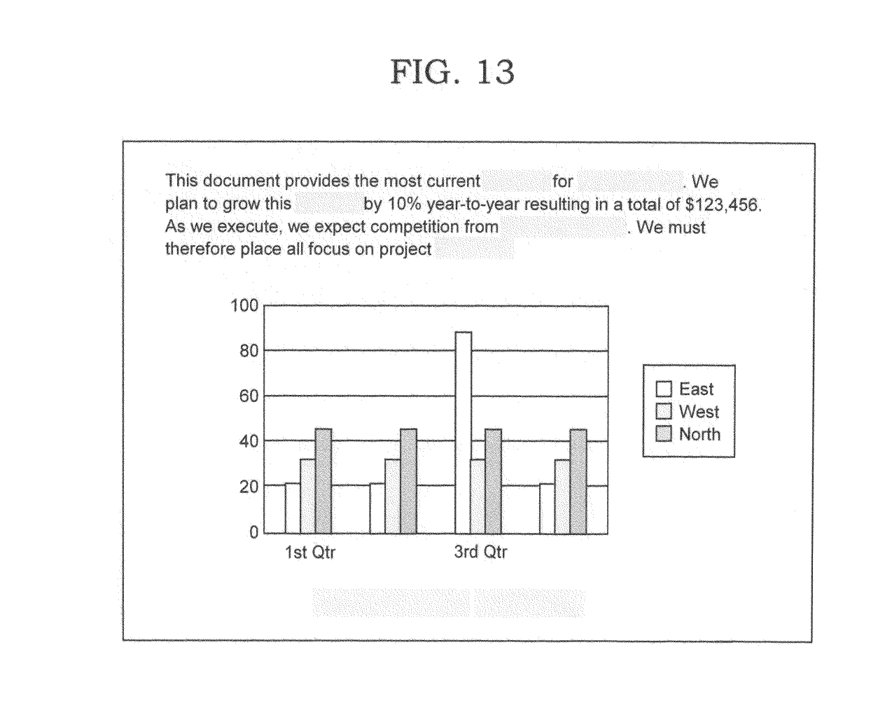

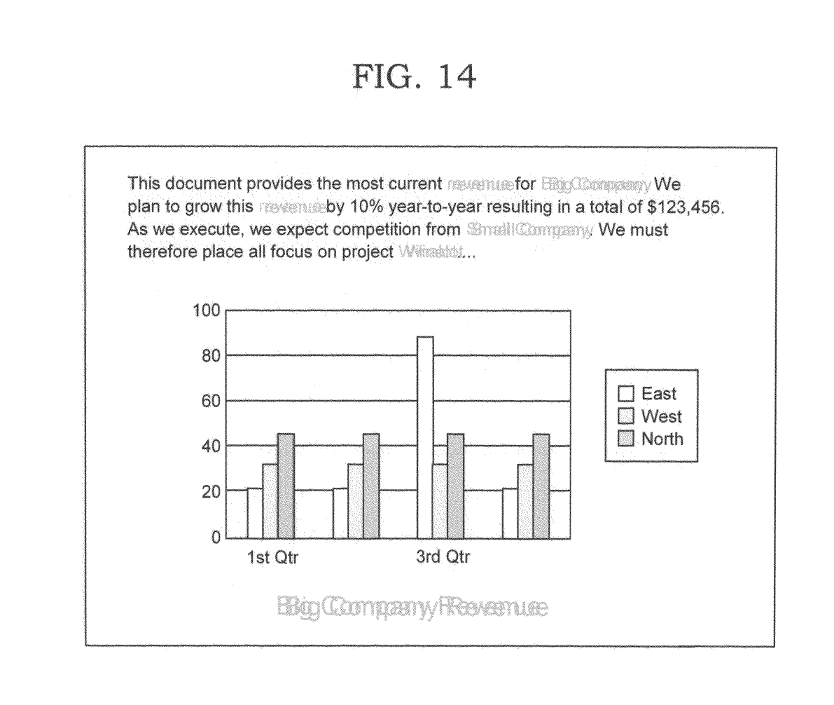

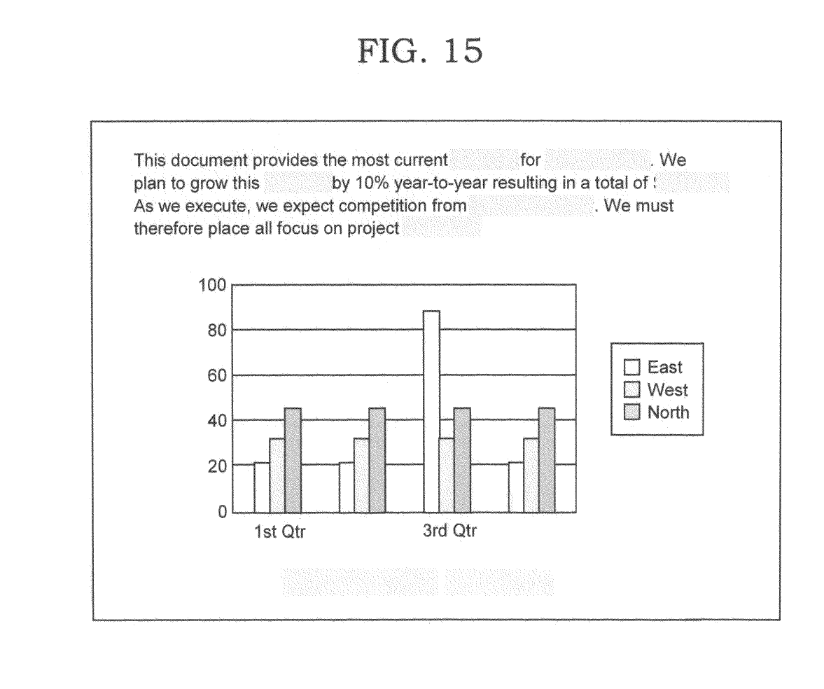

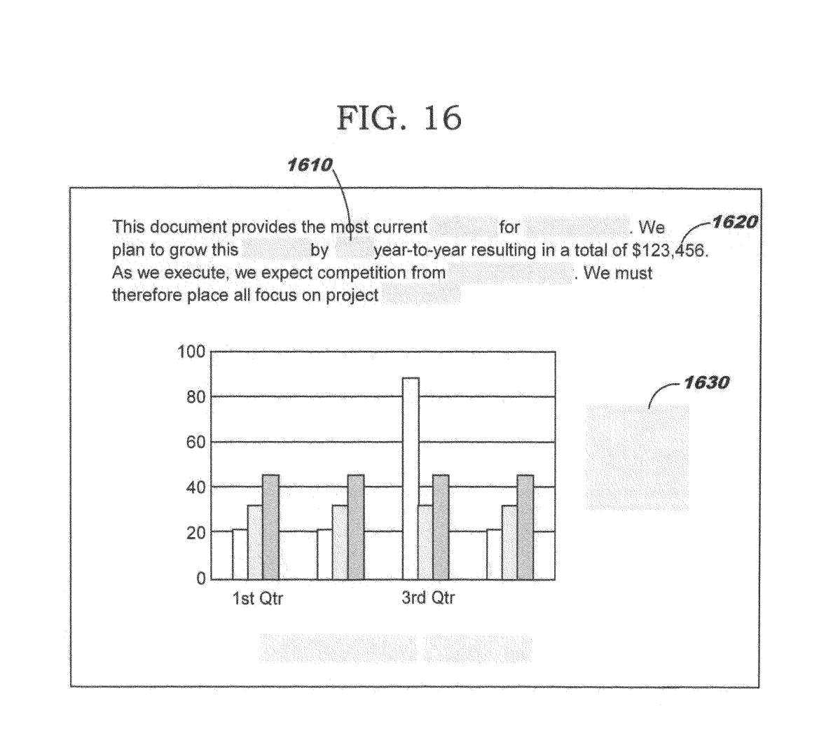

This dynamic security tuning is illustrated in FIGS. 15-16. In FIG. 15, selected portions of the document are obscured with rectangular shapes. FIG. 16 shows a number of changes, as compared to security protections in FIG. 15, where each of these changes results from the user dynamically changing the security of a portion of the document. In particular, reference number 1610 denotes a dynamically-applied blocking of the text “10%”; reference number 1620 denotes dynamically-applied unblocking of the text “$123,456”; and reference number 1630 denotes dynamically-applied blocking of a portion of the graphic that appears in the document.

A security database may store the user's predefined instructions. The dynamic blocking for security tuning (as illustrated at 1610 and 1630 of FIG. 16) may cause additional instructions to be added to this security database, and the dynamic unblocking (as illustrated at 1620 of FIG. 16) may cause existing instructions to be removed or deactivated.

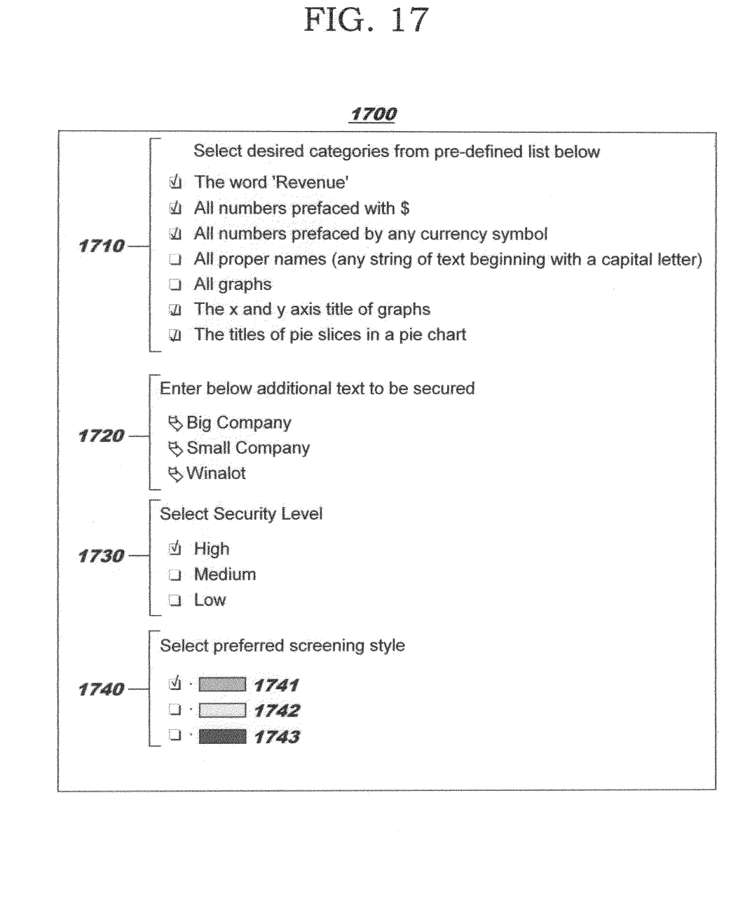

FIG. 17 provides a sample user interface menu 1700, illustrating how an embodiment of the present invention may enable a user to configure the security protection discussed with reference to FIGS. 10-16. In this example, menu 1700 displays a section 1710 where the user can select from among a number of predetermined categories. In this example, the selectable categories in section 1710 include the word “Revenue”; all numbers prefaced with a dollar sign “$”; all numbers prefaced with any currency symbol; all proper names (corresponding, in this example, to any string of text that begins with a capital letter); all graphs; the x-axis and y-axis title of graphs; and the titles of pie slices in graphs. Additional, fewer, or different selectable categories may be provided in menu 1700 without deviating from the scope of the present invention.

The sample menu 1700 provides another section 1720 where the user can type particular words or phrases that are to be secured. A text entry box may be provided, for example. In sample menu 1700, the user has typed 3 different entries at 1720. This enables the user to extend security protection beyond the choices offered at 1710.

Sample menu 1700 also provides a section 1730 where the user can select from among multiple security levels. A set of radio buttons may be provided for making this selection, for example. In sample menu 1700, the user has selected “High” security at 1730. The choice provided at 1730 may determine which of the approaches shown in FIGS. 12-14 is used for rendering security protection, for example.

Sample menu 1700 provides a section 1740 where the user can select from among multiple security screening styles. A set of radio buttons may be provided for making this selection, for example. In sample menu 1700, the user has selected a medium shading (see 1741) for a security graphic at 1740, as compared to a lighter shading (see 1742) and darker shading (see 1743) which were not selected. In one approach, the user's selection at 1740 works in conjunction with the user's selection at 1730, and the currently-selected screening style at 1740 is used when obscuring document portions according to the currently-selected security level at 1730. In another approach, the selections at 1730 are each statically associated with a different screening style, and section 1740 is not presented on menu 1700.

Optionally, an embodiment of the present invention may be adapted for observing a user's interactions and programmatically updating security protection in response. For example, the content of document portions which are dynamically selected for protection (as discussed with reference to FIG. 16) may be observed, and these observations may be used to generate additional information management instructions of the type shown at 1720 in FIG. 17. A number of alternative techniques that may be supported will now be discussed.

A selection mechanism, such as a checkbox, may be provided on menu 1700 (not shown) to enable to user to activate this observation mode. The observations may comprise monitoring the user's selections of particular content to be dynamically protected, as described above with reference to FIG. 16, for example. In one approach, upon detecting that the user has selected particular content for protection, an instruction for protecting this same content in subsequent renderings may be generated and stored in the security database. In another approach, the detecting may be monitoring for dynamic protection of content in predetermined categories instead of specific content values. Adding an information management instruction to the security database responsive to observing the user's interactions may be conditioned upon user acceptance of the generated instruction. A threshold may be used as a condition for generating such instructions, and/or for querying the user as to whether the instructions should be added. For example, the monitor may count a number of times the user dynamically selects particular content for protection, and the instruction may be generated when this count exceeds a predetermined threshold. The threshold may be configurable by the user.

Instead of (or in addition to) monitoring the content of document portions which are dynamically selected for protection, the monitoring may detect particular content (or content categories) for which the user dynamically toggles security protection off. An instruction may be changed to indicate that the user does not want this content (or content in this category) to be protected, responsive to the monitoring. Changing the instruction in the database may be conditioned upon user acceptance of the change. A threshold may be used as a condition for changing such instructions. For example, the information management instruction for a particular category may remain unchanged unless the user performs the toggling some threshold number of times.

The monitoring may alternatively, or additionally, detect that the user has toggled off the security protection for a particular document or document view. This may result in changing the information management instructions to indicate that subsequent renderings of the document or document view should not provide security protection. The changes may be applied conditionally, as discussed above (e.g., after requesting confirmation by the user, and/or only making the change after a threshold is reached pertaining to the number of times this toggling is performed).

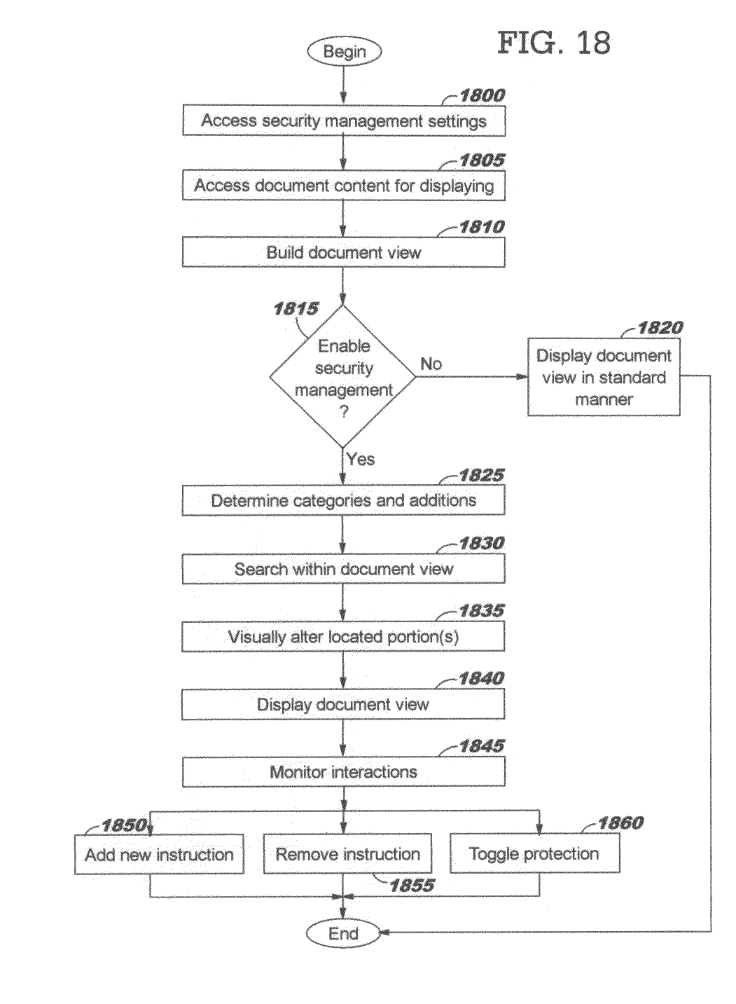

Referring now to FIG. 18, a flowchart is provided that depicts logic which may be used when implementing an embodiment of the present invention that provides protection for a portion or portions of a document using predefined information management instructions, as will now be described. Block 1800 accesses the security management settings for this user (which may been have configured, for example, using a menu of the type shown at 1700 in FIG. 17). These settings may be stored in, and accessed from, a security database. Block 1805 accesses document content that is to be displayed for this user. Block 1810 then builds a document view from that content.

Block 1815 tests whether the security management settings indicate that security protection using information management instructions is enabled. This may be determined, for example, by testing whether at least one security category was selected by the user (e.g., as shown at 1710 in FIG. 17) or at least one term (i.e., word or phrase) has been defined by the user for security protection (e.g., as shown at 1720 in FIG. 17). If this test has a negative result (i.e., indicating that the security management is not enabled), then Block 1820 displays the built document view in a standard manner, after which processing in FIG. 18 ends for this document view.

When the test at Block 1815 has a positive result, indicating that security management is enabled, processing continues at Block 1825 by determining applicable security categories and/or user-specified additions. This may comprise obtaining values entered by the user at 1710 and/or 1720 of FIG. 17.

After determining the applicable security categories and/or user-specified additions at Block 1825, Block 1830 searches for the corresponding document portion or portions in the built document view that was built at Block 1810. For each located portion, Block 1835 applies a visual alteration to the document view built at Block 1810. The document view is then displayed (Block 1840).

When the implementation supports dynamic monitoring and learning from user interactions, Block 1845 monitors the user's interactions with the displayed document view. If an additional document portion is dynamically selected by the user for protection, then a new information management instruction may be added (Block 1850) to represent that dynamically-selected portion (as discussed above with reference to FIGS. 15-16). Similarly, if the user selects an already-protected portion and requests togging off that protection, then an existing information management instruction may be removed (Block 1855) such that the portion will no longer be protected (as also discussed above with reference to FIGS. 15-16). Or, the user might simply request toggling off of the currently-provided security protection for the document view (Block 1860), in which case the document view is refreshed to omit the visual alterations of the portions located at Block 1830 (as discussed above with reference to FIGS. 10-11). FIG. 18 is then shown as exiting, for ease of drafting convenience, although it will be obvious to those of ordinary skill in the art that the monitoring at Block 1845 may continue, causing additional iterations of any of Blocks 1850-1860. Furthermore, security protection for a portion or portions of other document views may be provided by repeating logic depicted in FIG. 18 (e.g., beginning at Block 1805), although this repeating has not been illustrated.

As will be appreciated by one of skill in the art, embodiments of the present invention may be provided as (for example) methods, systems, and/or computer program products. The invention can take the form of an entirely hardware embodiment, an entirely software embodiment, or an embodiment containing both hardware and software elements. In a preferred embodiment, the invention is implemented in software, which includes (but is not limited to) firmware, resident software, microcode, etc. Furthermore, the present invention may take the form of a computer program product which is embodied on one or more computer-usable storage media (including, but not limited to, disk storage, CD-ROM, optical storage, and so forth) having computer-usable program code embodied therein, where this computer program product may be used by or in connection with a computer or any instruction execution system. For purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (“RAM”), a read-only memory (“ROM”), a rigid magnetic disk, and an optical disk. Current examples of optical disks include compact disk read-only memory (“CD-ROM”), compact disk read/write (“CD-R/W”), and DVD.

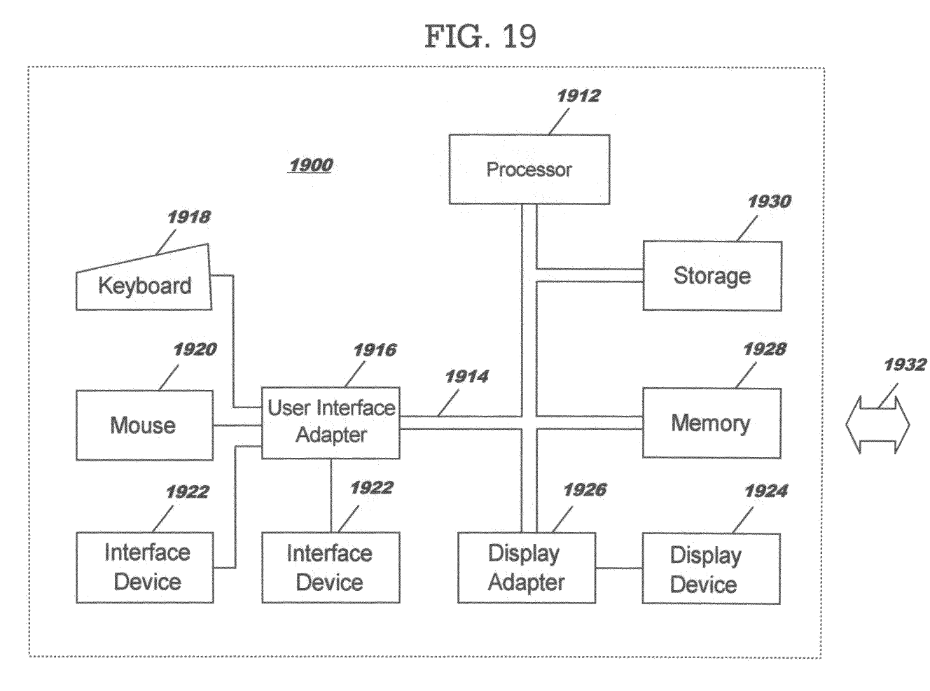

Referring now to FIG. 19, a data processing system 1900 suitable for storing and/or executing program code includes at least one processor 1912 coupled directly or indirectly to memory elements through a system bus 1914. The memory elements can include local memory 1928 employed during actual execution of the program code, bulk storage 1930, and cache memories (not shown) which provide temporary storage of at least some program code in order to reduce the number of times code must be retrieved from bulk storage during execution.

Input/output (“I/O”) devices (including but not limited to keyboards 1918, displays 1924, pointing devices 1920, other interface devices 1922, etc.) can be coupled to the system either directly or through intervening I/O controllers or adapters (1916, 1926).

Network adapters may also be coupled to the system to enable the data processing system to become coupled to other data processing systems or remote printers or storage devices through intervening private or public networks (as shown generally at 1932). Modems, cable modem attachments, wireless adapters, and Ethernet cards are just a few of the currently-available types of network adapters.

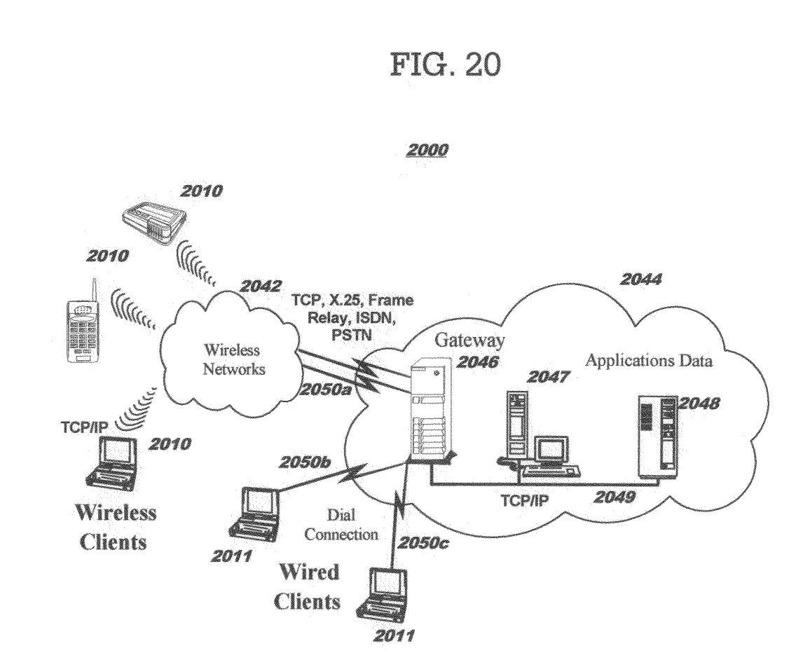

FIG. 20 illustrates a data processing network environment 2000 in which the present invention may be practiced. The data processing network 2000 may include a plurality of individual networks, such as wireless network 2042 and wired network 2044. A plurality of wireless devices 2010 may communicate over wireless network 2042, and a plurality of wired devices, shown in the figure (by way of illustration) as workstations 2011, may communicate over wired network 2044. Additionally, as those skilled in the art will appreciate, one or more local area networks (“LANs”) may be included (not shown), where a LAN may comprise a plurality of devices coupled to a host processor.

Still referring to FIG. 20, the networks 2042 and 2044 may also include mainframe computers or servers, such as a gateway computer 2046 or application server 2047 (which may access a data repository 2048). A gateway computer 2046 serves as a point of entry into each network, such as network 2044. The gateway 2046 may be preferably coupled to another network 2042 by means of a communications link 2050a. The gateway 2046 may also be directly coupled to one or more workstations 2011 using a communications link 2050b, 2050c, and/or may be indirectly coupled to such devices. The gateway computer 2046 may be implemented utilizing an Enterprise Systems Architecture/390® computer available from IBM. Depending on the application, a midrange computer, such as an Application System/400® (also known as an AS/400®), iSeries®, System i™, and so forth may be employed. (“Enterprise Systems Architecture/390”, “Application System/400”, “AS/400”, and “iSeries” are registered trademarks of IBM in the United States, other countries, or both, and “System i” is a trademark of IBM.)

The gateway computer 2046 may also be coupled 2049 to a storage device (such as data repository 2048).

Those skilled in the art will appreciate that the gateway computer 2046 may be located a great geographic distance from the network 2042, and similarly, the wireless devices 2010 and/or workstations 2011 may be located some distance from the networks 2042 and 2044, respectively. For example, the network 2042 may be located in California, while the gateway 2046 may be located in Texas, and one or more of the workstations 2011 may be located in Florida. The wireless devices 2010 may connect to the wireless network 2042 using a networking protocol such as the Transmission Control Protocol/Internet Protocol (“TCP/IP”) over a number of alternative connection media, such as cellular phone, radio frequency networks, satellite networks, etc. The wireless network 2042 preferably connects to the gateway 2046 using a network connection 2050a such as TCP or User Datagram Protocol (“UDP”) over IP, X.25, Frame Relay, Integrated Services Digital Network (“ISDN”), Public Switched Telephone Network (“PSTN”), etc. The workstations 2011 may connect directly to the gateway 2046 using dial connections 2050b or 2050c. Further, the wireless network 2042 and network 2044 may connect to one or more other networks (not shown), in an analogous manner to that depicted in FIG. 20.

The present invention has been described with reference to flow diagrams and/or block diagrams according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flow diagram flow or flows and/or block diagram block or blocks.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method of information management for displayed information, comprising:
building a view of information for display;
applying a user-defined viewing aperture to the built view, thereby creating a protected view where a first portion of the information that is displayable within the viewing aperture is not visually altered and is therefore unprotected while remaining portions of the information that are not displayable within the viewing aperture are protected by visually altering those remaining portions; and
displaying the protected view on a display.

2. The method according to claim 1, wherein the viewing aperture is defined according to coordinates of four corners of a rectangle.

3. The method according to claim 1, wherein the viewing aperture is defined as a particular number of lines of text that are to be displayed therein.

4. The method according to claim 1, further comprising:
changing a location of the viewing aperture on the display, subsequent to the displaying, responsive to corresponding movement of a pointing device; and
applying the viewing aperture to the built view to create a new protected view, wherein:
the first portion of the information that is displayable within the viewing aperture is not visually altered, and is therefore unprotected, is moved to correspond to the changed location of the viewing aperture; and
the remaining portions of the information that are not displayable within the viewing aperture, are that protected by visually altering those remaining portions, are changed to correspond to the changed location of the viewing aperture; and
the displaying displays the new protected view.

5. The method according to claim 1, wherein the visually altering of the remaining portions comprises visually obscuring those remaining portions.

6. The method according to claim 1, wherein the visually altering of the remaining portions comprises visually blocking those remaining portions.

7. The method according to claim 1, wherein the applying comprises applying more than one user-defined viewing aperture to the built view, thereby creating a protected view where each viewing aperture displays a different portion of the information without visually altering that information, such that each different portion is therefore unprotected, while remaining portions of the information that are not displayable within any of the viewing apertures are protected by visually altering those remaining portions; and
displaying the protected view on a display.

8. The method according to claim 1, wherein the viewing aperture is defined as a particular graphic that is to be displayed within the viewing aperture and that is therefore not to be visually altered.

9. A computer program product for information management of displayed information, the computer program product embodied on at least one computer-readable medium and comprising computer-readable program code for:
building a view of information for display;
applying user-defined information management instructions to the built view, thereby creating a protected view where portions of the information corresponding to the information management instructions are visually altered and are therefore protected for displaying while remaining portions of the information are not visually altered and are therefore not protected for displaying; and
displaying the protected view on a display.

10. The computer program product according to claim 9, wherein the user-defined information management instructions comprise selectable categories which have been selected by a user.

11. The computer program product according to claim 9, wherein the user-defined information management instructions comprise user-entered text.

12. The computer program product according to claim 9, wherein the computer-readable program code for applying further comprises computer-readable program code for programmatically searching the information to locate the portions of the information corresponding to the information management instructions.

13. The computer program product according to claim 9, wherein the user-defined information management instructions comprise at least one user-identified graphic.

14. The computer program product according to claim 9, further comprising computer-readable program code for dynamically learning at least one additional information management instruction by observing interactions of a user; and wherein the computer-readable program code for applying also applies each dynamically-learned additional information management instruction.

15. The computer program product according to claim 9, further comprising computer-readable program code for dynamically learning at least one of the information management instructions to be removed by observing interactions of a user; and wherein the computer-readable program code for applying does not apply any dynamically-learned information management instruction that is to be removed.

16. The computer program product according to claim 9, wherein the computer-readable program code for visually altering uses a plurality of different visual styles that correspond to different degrees of information protection.

17. The computer program product according to claim 9, further comprising computer-readable program code for enabling the visually altering of a built view to be dynamically toggled off by a user.

18. The computer program product according to claim 9, further comprising computer-readable program code for enabling the visually altering of portions of a built view to be dynamically toggled off by a user.

19. A system for information management of displayed information, comprising:
information for display, wherein at least a subset of the information is sensitive;
a display for displaying the information;
a view-builder for building a view of the information for display;
an applier for applying user-defined information management instructions to the built view, thereby creating a protected view where portions of the information corresponding to the information management instructions are visually altered and are therefore protected for displaying while remaining portions of the information are not visually altered and are therefore not protected for displaying; and
a displayer for displaying the protected view on the display.

20. The system according to claim 19, wherein:
the user-defined information management instructions comprise at least one of selectable categories which have been selected by a user and user-entered text; and
the applier further comprises programmatically searching the information to locate the portions of the information corresponding to the information management instructions.
